(19) United States
(12) Patent Application Publication
(10) Pub. No.: US 2007/0293188 A1
(43) Pub. Date: Dec. 20, 2007

(54) Method and system for an audio speaker with proximity sensing

(76) Inventors: Philip John Houghton, Surrey (CA); David William Hylands, Surrey (CA); Darwin Ivor Rambo, Surrey (CA); Wilfred Paul LeBlanc, Vancouver (CA); Daniel Edward Nesbitt, Vancouver (CA)

Correspondence Address: MCANDREWS HELD & MALLOY, LTD, 500 WEST MADISON STREET, SUITE 3400, CHICAGO, IL, 60661, US

(21) Appl. No.: 11/471,160

(22) Filed: Jun. 20, 2006

(51) Int. Cl. H04M 11/04

(52) U.S. Cl. 455/404.2

(57) ABSTRACT

Aspects of a method and system for an audio speaker with proximity sensing are presented. Aspects of a system for audio signal processing may include a proximity detector that enables adjustment of audio volume of a speaker in a wireless communication system based on detection of a location of at least one object in relation to the speaker.

### CROSS-REFERENCE TO RELATED APPLICATIONS/INCORPORATION BY REFERENCE

NOT APPLICABLE.

### FIELD OF THE INVENTION

Certain embodiments of the invention relate to wireless handheld communication devices. More specifically, certain embodiments of the invention relate to a method and system for an audio speaker with proximity sensing.

### BACKGROUND OF THE INVENTION

The development and deployment of new wireless technologies and increased bandwidth has spawned a new breed of wireless devices, which have the capability to exploit these new wireless technologies. These wireless devices include cellular telephones, personal digital assistants, smartphones and other handheld type wireless communication devices. Smartphones are hybrid communication devices having at least some of the capabilities and features of a cellular telephone and at least some of the capabilities and features of a personal digital assistant. For example, a smartphone may have an operating system (OS), enhanced display, and input/output (I/O) expansion slots, in addition to some of the traditional telephone functions. The operating system may be adapted to facilitate integration of voice and data services such as dialing directly from a telephone address book and displaying a calling party's information. The enhanced display may, for example, be a high-resolution color display, which may have touch screen capability.

Some of these wireless devices comprise a camera that may be capable of taking still photographs and/or short video clips. The integration of camera functionality in a hybrid communication device may change usage modes for the users of these hybrid communication devices. In a more conventional usage mode for a cellular telephone with an integrated audio speaker and microphone, for example, the user may hold the communication device so that the audio speaker is close to their ear, and the microphone is as close as possible to his mouth. When utilizing a hybrid communication device, the user may hold the device at a distance, for example at arm's length, to enable taking of self-photographs. However, the user may still wish to utilize the hybrid communication device to engage in audio communication, and/or to hear audio output, while holding the device at a distance.

Ergonomic requirements may limit the physical size of the hybrid communications device even as increasing levels of functionality are incorporated. In some cases, a camera, a video display, and/or keypad may be physically located on one side of the hybrid communications device, while the audio speaker may be physically located on the opposite side. This may create a requirement that the audio speaker in the hybrid communications device be larger in at least one physical dimension, and be capable of reproducing sound at higher sound pressure levels, than audio speakers in some conventional communication devices. A sound pressure level may be a measure of a volume level from an audio speaker. A sound pressure level may be measured in units of decibels (dB), for example. While the larger audio speaker may enable the user to hear audio output while holding the hybrid communications device at a distance, the larger audio speaker may produce dangerously high sound pressure levels, which may damage the user's hearing, if the user attempts to hold the audio speaker close to their ear, as one would do in more conventional communication device usage modes.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for an audio speaker with proximity sensing, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary mobile terminal that may be utilized in a wireless communication system in connection with an embodiment of the invention.

FIG. 2A is a block diagram of a front view of an exemplary mobile terminal, in accordance with an embodiment of the invention.

FIG. 2B is a block diagram of a rear view of an exemplary mobile terminal illustrating a proximity detector integrated into a speaker, in accordance with an embodiment of the invention.

FIG. 2C is a block diagram of a rear view of an exemplary mobile terminal illustrating discrete proximity detector and speaker components, in accordance with an embodiment of the invention.

FIG. 3A is a diagram illustrating exemplary non-detection of an object by a speaker with proximity sensing, in accordance with an embodiment of the invention.

FIG. 3B is a diagram illustrating exemplary detection of an object by a speaker with proximity sensing, in accordance with an embodiment of the invention.

FIG. 3C is a diagram illustrating exemplary detection of an object by a speaker with direct contact sensing, in accordance with an embodiment of the invention.

FIG. 3D is an a diagram illustrating exemplary non-detection of an object by a speaker with proximity sensing based on electromagnetic field perturbation, in accordance with an embodiment of the invention.

FIG. 3E is a diagram illustrating exemplary detection of an object by a speaker with proximity sensing based on electromagnetic field perturbation, in accordance with an embodiment of the invention.

FIG. 4 is a flow chart illustrating exemplary steps for an audio speaker with proximity sensing, in accordance with an embodiment of the invention.

### DETAILED DESCRIPTION OF THE INVENTION

Certain embodiments of the invention may be found in a method and system for an audio speaker with proximity sensing. In various embodiments of the invention, a sound pressure level produced by an audio speaker may be adjusted based on detected proximity of an object to the audio speaker. In one aspect, the audio speaker may be integrated into a communication device. The object may be a user of the communication device. More specifically, the object of interest may be the ear of the user. In various embodiments of the invention, the audio speaker with proximity sensing may reduce audio volume of a communication device as the user places the audio speaker in close proximity to their ear. The audio volume of the speaker may be reduced to a level to avoid damage to the user's hearing.

Various embodiments of the invention may be utilized in a hybrid communication device, for example a smartphone, which comprises an audio speaker with proximity sensing. An exemplary embodiment of the invention may be utilized for video-conferencing applications, in which a user may hold the hybrid communication device at a distance while viewing a video screen on the hybrid communication device, and/or taking still and/or motion pictures utilizing the hybrid communication device. While viewing the video screen, and/or taking pictures, the speaker may be adjusted to produce a high audio volume. When the user subsequently places the audio speaker in close proximity to their ear, the speaker with proximity sensing may detect an object in close proximity and cause a reduction in the audio volume of the speaker.

Similarly, various embodiments of the invention may be utilized in connection with a hands free mode for some hybrid communications devices, in which the user may engage in conversation while not holding the hybrid communication device, for example, while the user is driving an automobile. When the user picks up the hybrid communication device and places the audio speaker in close proximity to their ear, the speaker with proximity sensing may detect an object in close proximity and cause a reduction in the audio volume of the speaker.

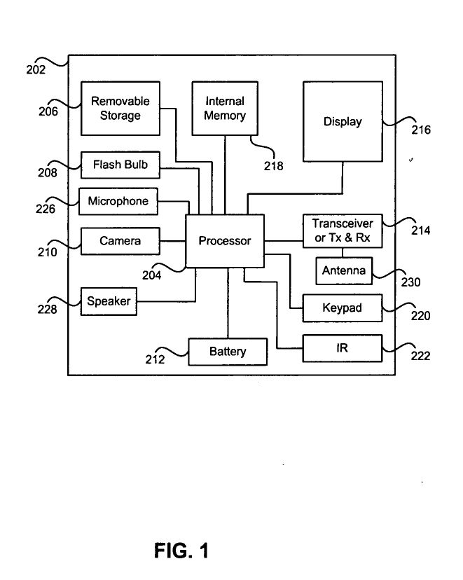

FIG. 1 is a block diagram of an exemplary mobile terminal that may be utilized in a wireless communication system in connection with an embodiment of the invention. Referring to FIG. 1, there is shown a mobile terminal 202. The mobile terminal 202 may comprise a processor 204, a removable storage 206, a flash bulb 208, a camera 210, a battery 212, a transceiver 214, a display 216, an internal memory 218, a keypad 220, an infrared (IR) interface 222, a microphone 226, a speaker 228 and an antenna 230.

The processor 204 may comprise suitable logic, circuitry, and/or code that may interpret and/or execute instructions. The instructions may be in the form of binary code. The processor 204 may be, for example, a reduced instruction set computer (RISC) processor, a microprocessor without interlocked pipeline stages (MIPS) processor, a central processing unit (CPU), an ARM processor, a digital signal processor (DSP), an application specific integrated circuit (ASIC), microprocessor, a microcontroller, or other type of processor.

The internal memory 218 may comprise suitable logic, circuitry, and/or code that may comprise storage devices that retain binary information for an interval of time. The stored binary information may be assigned physical resources within the memory 218 for the storage. The stored binary information may be subsequently available for retrieval. Retrieved binary information may be output by the memory 218 and communicated to other devices, components, and/or subsystems that may be communicatively coupled, directly and/or indirectly, to the memory 218. The memory 218 may enable the stored binary information to remain stored and/or available for subsequent retrieval until the resources allocated for the storage are deallocated. Physical resources may be deallocated based on a received instruction that the stored binary information be erased from the memory 218, or based on a received instruction that the physical resources be allocated for the storage of subsequent binary information. The memory 218 may utilize a plurality of storage medium technologies such as volatile memory, for example random access memory (RAM), and/or nonvolatile memory, for example electrically erasable programmable read only memory (EEPROM).

The IR interface 222 may comprise suitable logic, circuitry, and/or code that may enable transmission and reception of signals whose frequencies and/or wavelengths are within the infrared spectrum. Information to be transmitted by the IR interface 222 may be encoded prior to transmission. A received IR signal may be decoded by the IR interface 222 to receive information.

The removable storage 206 may comprise suitable logic, circuitry, and/or code that may comprise cartridge and/or disk-based storage devices that may be inserted in the mobile terminal 202, and subsequently removed and inserted into another device, such as another mobile terminal, a personal digital assistant (PDA) device, or computer, for example. CompactFlash (CF), SmartMedia, Memory Stick, Secure Data (SD) Memory Card, and Extreme Data (xD) Picture Card may comprise exemplary removable storage device types.

The flash bulb 208 may be an LED or other type of flash bulb. An exemplary flash bulb 208 may be a glass bulb filled with fine gauge aluminum or magnesium foil that may be ignited by electricity to produce a short-duration, high-intensity light flash for taking photographs.

The camera 210 may comprise suitable logic, circuitry, and/or code that may enable capture of images at various resolutions, as measured in picture elements (pixels) for example, such as 640×480 pixels. The camera 210 may be an integrated video graphics array (VGA) digital complementary metal oxide semiconductor (CMOS) or charge-coupled device (CCD) camera capable of capturing images at various resolutions such as 640 pixels×480 pixels, for example. The camera 210 may also be capable of capturing images at quarter VGA resolution, for example 320×420 pixels. The camera 210 may be utilized to capture, for example, H.263 video in a 3GP format at 15 frames per second (fps). The camera 210 may be utilized to enable capture of a series of consecutive images that may subsequently be utilized to produce a series of slides. The time interval between the capture of each consecutive image may be preset or may be user adjustable.

The battery 212 may be a device that converts a non-electrical form of energy, for example chemical energy, into electrical energy. The battery 212 may comprise one or more electric cells that are connected to generate a direct current. A single cell may comprise a positive electrode, a negative electrode, and an electrolyte. The electrolyte may enable the transfer of electrons between the positive and negative electrodes. An exemplary battery 212 may be at least one dry cell, as in an alkaline dry cell battery, or at least one lithium ion battery cell, utilized in many consumer electronics devices, for example. The battery 212 may be rechargeable or nonrechargeable.

The transceiver 214 may comprise suitable logic, circuitry, and/or code that may enable the transmitting and receiving of analog and/or digital signals. An exemplary transceiver may be utilized to enable a mobile terminal 102 to communicate via an RF channel 112, for example. The transceiver 214 may comprise transmitter and receiver functionality. Transmitter functionality may enable the transceiver 214 to generate a carrier signal, which may be utilized to modulate an information signal derived from audio, video, and/or data sources. The modulated information signal may be radiated as an electromagnetic, or radio, signal via an antenna 230. Receiver functionality may enable the transceiver 214 to utilize a carrier signal to decode a radio signal, received via the antenna 230, so as to retrieve an information signal. Although a transceiver is illustrated, the invention is not so limited. Accordingly, separate transmit and receive circuitry may be utilized wherein the transmitter circuitry may enable transmitter functionality, and the receiver circuitry may enable receiver functionality, for example.

The transmitter 214, transmitter circuitry, and/or receiver circuitry enable communications when utilized in a plurality of wireless communications systems, for example global system for mobile communications (GSM), code division multiple access (CDMA) and other spread spectrum variants thereof, advanced mobile phone system (AMPS) and its variants, systems and variants of systems specified by IEEE 802.11 standards, Bluetooth, personal digital cellular (PDC), personal handyphone system (PHS), cellular digital packet data (CDPD), and integrated digital enhanced network (IDEN) The antenna 230 may be any apparatus, which may be utilized for sending and/or receiving electromagnetic signals. One or more antennas may be utilized.

The display 216 may be a device that receives electrical signals, and/or binary information, and presents the electrical signals and/or binary information in a visual form. The display 216 may be similar to a display in a standardized telephone, smart phone or other communication device display. The visual presentation from the display 216 may be black and white, or color. An exemplary display 216 may be a thin film transistor (TFT) liquid crystal display (LCD), for example, or other type of display. The physical form of the display 216 may be rectangular, and may be characterized by a diagonal measurement, as measured in inches, for example. The display 216 may also be characterized by the number of pixels contained in the display area, for example 640 pixels×480 pixels. The display 216 that has color visual presentation capabilities may also have the capability of displaying, for example, 65,536 colors.

The keypad 220 may comprise alphanumeric keys, symbols keys, and navigation and function buttons. On other embodiments of the invention, the keypad may be a soft keypad that may be displayed on the display 216 to facilitate navigation, and input.

The microphone 226 may comprise suitable logic, circuitry, and/or code that may enable sound energy to be converted to an electrical signal. An exemplary microphone 226 may comprise a diaphragm made of film or foil that vibrates in response to pressure generated by sound energy. The vibration of the diaphragm may generate an electrical current. The microphone 226 may be a carbon microphone, an electrostatic, or condenser, microphone, an electret microphone, a crystal microphone, a dynamic microphone, a ribbon microphone, a piezo microphone, or a laser microphone, for example.

The speaker 228 may comprise suitable logic, circuitry, and/or code that may enable an electrical signal to be converted to sound energy. The sound energy may be characterized by a sound pressure level, or audio volume. A change in amplitude for an electrical signal, as measured in volts for example, may result in a corresponding change in sound pressure level produced by the speaker 228, as measured in dB for example. An exemplary speaker 228 may comprise a diaphragm that vibrates in response to an electrical signal from an amplifier. The vibrations may generate the sound energy. The speaker 228 may be a dynamic speaker, an electrostatic speaker, a piezoelectric speaker, a plasma arc speaker, for example.

In operation, the battery 212 may provide electrical energy that enables operation of the processor 204, removable storage 206, flash bulb 208, camera 210, transceiver 214, display 216, internal memory 218, keypad 220, IR interface 222, microphone 226, and speaker 228. The keypad 220 may be utilized to control the operation of the mobile terminal 202. The mobile terminal 202 may be utilized to retrieve information comprising audio, video, and/or data from removable storage 206 and/or internal memory 218. The retrieved information may be displayed on the display 216, and/or presented via the speaker 228, and/or transmitted via the transceiver 214. Information may also be communicated via the IR interface 222. The mobile terminal 202 may also be utilized to receive audio signals from the microphone 226, and/or images and/or video from the camera 210. The audio signals, and/or images and/or video may be stored in internal memory 218, and/or removable storage 206, and/or transmitted via the transceiver 214. The mobile terminal 202 may also be utilized to receive information via the transceiver 214, and/or IR interface 222. The received information may be displayed on the display 216, presented via the speaker 228, stored in internal memory 218 and/or removable storage 206, and/or transmitted via the transceiver 214, or IR interface 222.

The processor 204 may retrieve stored data, visual, and/or audio information from internal memory 218, and/or removable storage 206. The processor 204 may process the retrieved information to generate a visual signal, and/or audio signal. The processor 204 may communicate the visual signal to the display 216. The display 216 may represent the visual signal in a viewable format. The processor 204 may communicate the audio signal to the speaker 228. The speaker 228 may convert the audio signal to sound energy.

The processor 204 may also retrieve stored data, visual and/or audio information from internal memory 218, and/or removable storage 206. The processor 204 may process the retrieved information to generate signals that are communicated to the transceiver 214. The transceiver 214 may generate radio signals that are transmitted via the antenna 230. The processor 204 may also generate signals that are communicated to the IR interface 222. The IR interface 222 may generate and transmit IR signals.

The microphone 226 may detect sound energy. The sound energy may be converted to an audio signal that is communicated to the processor. The camera 210 may generate images and/or video. The camera 210 may determine an ambient light level in connection with the generation of the images and/or video. Based on the ambient light level, the camera 210 may communicate information to the processor 204. The information may comprise a request that the flash bulb 208 be activated in connection with the generation of the images and/or video by the camera 210. Based on the request, the processor 204 may communicate a signal to the flash bulb 208 instructing the flash bulb to operate in accordance with the request. The flash bulb 208 may operate in response to the request from the processor 204. When activated, the flash bulb 208 may increase the level of ambient light within a proximal region to the mobile terminal 202.

The processor 204 may receive an audio signal from the microphone 226, and/or images and/or video from the camera 210. The processor 204 may process the audio signal and/or images and/or video. The processed images and/or video may be communicated to the display 216. The display 216 may represent the processed images and/or video in a viewable format. The processed audio signal may be communicated to the speaker 228. The speaker 228 may convert the processed audio signal to sound energy. The processor 204 may also communicate the processed audio signal and/or images and/or video to the transceiver 214. The transceiver 214 may generate radio signals that are transmitted via the antenna 230. The processor 204 may also communicate the processed audio signal and/or images and/or video to the IR interface 222. The IR interface 222 may generate and transmit IR signals. The processor 204 may also communicate a binary representation of the processed audio signal and/or images and/or video to internal memory 218, and/or removable storage 206. The internal memory 218, and/or removable storage 206 may store the binary representation of the processed audio signal and/or images and/or video.

The transceiver 214 may receive radio signals via the antenna 230. The transceiver 214 may retrieve information signals contained in the radio signals. The information signals may be communicated to the processor 204. The processor 204 may process the information signals to generate binary information that may be stored in internal memory 218, and/or removable storage 206.

The IR interface 222 may receive IR signals. The IR interface 222 may retrieve information signals contained in the IR signals. The information signals may be communicated to the processor 204. The processor 204 may process the information signals to generate binary information that may be stored in internal memory 218, and/or removable storage 206.

The processor 204 may also process the information signals from the transceiver 214 and/or IR interface 222 to generate visual signals and/or audio signals. The processor 204 may communicate the visual signals to the display 216. The display 216 may represent the visual signals in a viewable format. The processor 204 may communicate the audio signals to the speaker 228. The speaker 228 may convert the audio signals to sound energy. Based on input from the keypad 220 and/or microphone 226, the processor 204 may generate information. The information may be displayed on the display 216, presented via the speaker 228, stored in internal memory 218 and/or removable storage 206, transmitted via the transceiver 214, and/or transmitted via the IR interface 222.

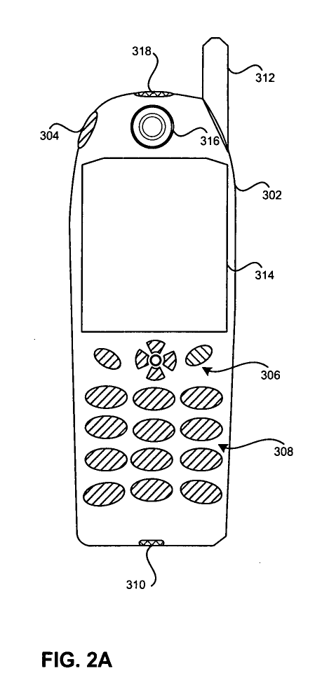

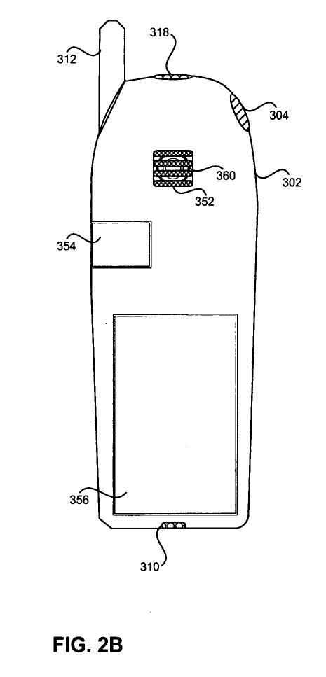

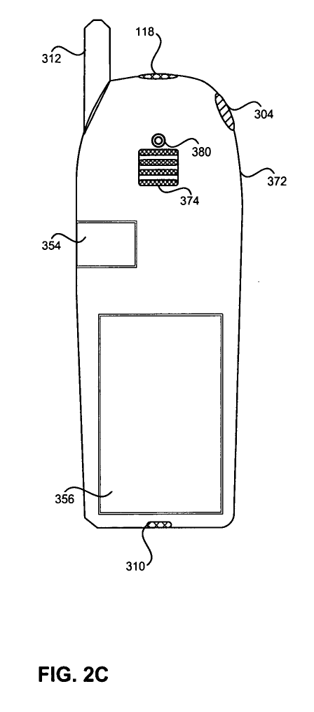

FIG. 2A is a block diagram of a front view of an exemplary mobile terminal, in accordance with an embodiment of the invention. Referring to FIG. 2A, there is shown a mobile terminal 302. The mobile terminal 302 may represent an embodiment of the mobile terminal 202 (FIG. 1). The mobile terminal 302 may comprise a capture and send button 304, navigation and software function buttons 306, alphanumeric and symbol keys 308, a microphone 310, an antenna 312, a display 314, a camera 316, and an IR interface 318. The camera 316 may be substantially as described for the camera 210. The capture and send button 304 may be utilized to activate the camera 316 for capturing images and/or video.

The navigation and software function buttons 306 may include a plurality of buttons that may be utilized to control the operation of the mobile terminal 302. The navigation and software function buttons 306 may be utilized to perform preset and/or software enabled functions. The keypad 220 may comprise the functionality of the navigation and software function buttons 306.

The alphanumeric and symbol keys 308 may also be utilized to perform functions that are substantially as described for the keypad 220. The alphanumeric and symbol keys 308 may be utilized for entry of numbers, for example telephone numbers, which enable the mobile terminal 302 to establish communications with other communication devices, for example.

The microphone 310 may be substantially as described for the microphone 226. The antenna 312 may be substantially as described for the antenna 230. The display 314 may be substantially as described for the display 216. The IR interface 318 may be substantially as described for the IR interface 222.

In operation, a user of the mobile terminal 302 may practice a more conventional usage by holding the mobile terminal 302 such that the microphone 310 is in close proximity to their mouth. While practicing a mode of usage more consistent with a hybrid communications device, the user may point the camera 316 at an object of interest, and subsequently active the capture and send button 304 to enable the camera 316 to capture images and/or video in connection to the object of interest. The user may, for example, hold the mobile terminal 302 at arm's length while pointing the camera 316 to capture self-images and/or video. The user may utilize the navigation and software function buttons 306, and/or alphanumeric and symbol keys 308 to activate functions within the mobile terminal 302 the enable storage and/or transmission of the captured images and/or video. The mobile terminal 302 may transmit information via the antenna 312, and/or IR interface 318. The mobile terminal 302 may also be utilized to receive information via the antenna 312, and/or IR interface 318.

FIG. 2B is a block diagram of a rear view of an exemplary mobile terminal illustrating a proximity detector integrated into a speaker, in accordance with an embodiment of the invention. Referring to FIG. 2B, there is shown a rear view of the mobile terminal 302 from FIG. 2A. The mobile terminal 302 may comprise a capture and send button 304, a microphone 310, an antenna 312, an IR interface 318, an expansion card 354, a battery 356, a speaker 352, and a proximity detector 360. The capture and send button 304, the microphone 310, the antenna 312, and the IR interface 318 may be as described in FIG. 2A.

The expansion card 354 may be substantially as described for the removable storage 206 (FIG. 1). The battery 356 may be substantially as described for the battery 212. The speaker 352 may be substantially as described for the speaker 228.

The proximity detector 360 may detect objects in the proximity of the speaker 352. Based on the detection, the proximity detector 360 may cause an adjustment in the audio volume the speaker 352. When a user places the speaker 352 close to his ear, the proximity detector 360 may cause a reduction in the audio volume of the speaker 352. When the user places the speaker 352 at a greater distance from his ear, the proximity detector 360 may cause an increase in the audio volume of the speaker 352. In the exemplary embodiment shown in FIG. 2B, the proximity detector 360 may be integrated as a component within the speaker 352.

The proximity detector 360 may perform the proximity detection function based on direct contact between the object and the speaker 352, by measuring a distance between an object and the speaker 352, and/or by detection motion in the proximity of the speaker 352.

In one exemplary embodiment of the invention, the proximity detector 360 may utilize optical sensors. In this embodiment of the invention, the proximity detector 360 may comprise a plurality of illuminated light sources, and a plurality of light detectors. The light sources may emit light within a specified range of frequencies. The light detectors may detect incident light within the specified range of frequencies. When an object is distant from the speaker 352, the level of incident light within the range of frequencies detected at the light detectors may not indicate detected objects in the proximity of the speaker 352. The proximity detector 360 may communicate a signal indicating an initial level of incident light to the processor 204. As an object facing the rear view of the mobile terminal 302 approaches the speaker 352, light emitted from the light sources may be reflected by the object and detected by the light detectors. The proximity detector 360 may communicate a signal indicating the reflected level of incident light to the processor 204. When the level of detected light is greater than or equal to a threshold value, the proximity detector 360 may enable detection of one or more objects in the proximity of the speaker 352. The processor 204 may determine when the level of detected light is greater than or equal to the threshold value, for example. When the processor 204 determines that one or more objects are in the proximity of the speaker 352, the processor 204 may communicate a signal to the speaker 352 causing a reduction in the audio volume of the speaker 352.

When a subsequent level of reflected light is less than the threshold level, the proximity detector 360 may enable a determination that there are no objects detected in the proximity of the speaker 352. The processor 204 may determine when the level of detected light is less than the threshold value, for example. When the processor 204 determines that there are no objects within the proximity of the speaker 352, the processor 204 may communicate a signal to the speaker 352 causing an increase in the audio volume of the speaker 352.

In another exemplary embodiment of the invention, the proximity detector 360 may utilize Theremin principles. Theremin principles are based on research and/or inventions by Leon Theremin. In this embodiment, the proximity detector 360 may comprise a plurality of antennas. An alternating current (AC) signal of a given frequency may be communicated to each of the plurality of antennas. In response, each of the antennas within the proximity detector 360 may generate an electromagnetic signal in the proximity of each respective antenna. The electromagnetic signal may correspond to an electromagnetic field, also within the proximity of each respective antenna within the proximity detector 360. Each of the antennas within the proximity detector 360 may detect the electromagnetic field in the proximity of the respective antenna. When an object is distant from the speaker 352, each of the plurality of antennas within the proximity detector 360 may detect an initial electromagnetic field in the proximity of each respective antenna. Each detected initial electromagnetic field may be characterized by at least one frequency, at least one field direction vector, and a corresponding at least one field magnitude parameter. Each antenna within the proximity detector 360 may generate an initial AC current signal, with an associated received signal frequency, based on the detected initial electromagnetic field. The initial AC current signal may be communicated to the processor 204 by the proximity detector 360.

As an object approaches the speaker 352, the electrical conductivity properties of the object may result in an altered electromagnetic field in the proximity of one or more of the antennas within the proximity detector 360 for which one or more frequencies, field direction vectors, and/or field magnitude parameters are different from those of the corresponding initial electromagnetic field. Based on a measure of difference between an initial electromagnetic field and a corresponding altered electromagnetic field the proximity detector 360 may generate a modified AC current signal. The modified AC current signal may be communicated to the processor 204 by the proximity detector 360. Based on a threshold level of change in current level between the initial AC current signal and the corresponding modified AC current signal, the proximity detector 360 may enable detection of one or more objects in the proximity of the speaker 352. The processor 204 may determine when the level of change in current level is greater than or equal to the threshold level, for example. When the processor 204 determines that one or more objects are in the proximity of the speaker 352, the processor 204 may communicate a signal to the speaker 352 causing a reduction in the sound pressure level of sound energy generated by the speaker 352.

When a subsequent level of change in current level between the initial AC current signal, and current modified AC current signal is less than the threshold level, the proximity detector 360 may enable a determination that there are no objects detected in the proximity of the speaker 352. The processor 204 may determine when the level of change in current level is less than the threshold value, for example. When the processor 204 determines that there are no objects are in the proximity of the speaker 352, the processor 204 may communicate a signal to the speaker 352 causing an increase in the audio volume of the speaker 352.

In various embodiments of the invention that utilize Theremin principles, beamforming techniques may be utilized to generate one or more directional electromagnetic fields from the plurality of antennas. The directional electromagnetic fields may enable electromagnetic field energy generated by the plurality of antennas in the form of a narrow beam that may detect the proximity of objects that are facing the rear view of mobile terminal 302 while not detecting the proximity of objects that are facing the front view of the mobile terminal 302. In this aspect, a user's ear, which is facing the rear view of the mobile terminal 302, and is a given distance from the speaker 352, may cause a modification in the sound pressure level generated by the speaker 352, while a user's hand, which is facing the front view of the mobile terminal 302, and is the same distance from the speaker 352, may not cause a modification in the sound pressure level generated by the speaker 352.

In another exemplary embodiment of the invention, the proximity detector 360 may utilize radio detection and ranging (RADAR). In various embodiments of the invention, the proximity detector 360 may comprise one or more antennas. In a single antenna embodiment, the antenna within the proximity detector 360 may transmit a radio signal. The radio signal may be transmitted directionally to enable the proximity of object facing the rear view of the mobile terminal 302. The radio signal may be transmitted within a range of frequencies. The antenna within the proximity detector 360 may detect signals received within the range of frequencies. The proximity detector 360 may communicate a signal indicating a signal level of a received radio signal to the processor 204.

As an object facing the rear view of the mobile terminal 302 approaches the speaker 352, radio signals transmitted by the antenna within the proximity detector 360 may be reflected by the object and detected by the antenna. The proximity detector 360 may communicate a signal indicating the reflected radio signal level to the processor 204. When the reflected radio signal level is greater than or equal to a threshold value, the proximity detector 360 may enable detection of one or more objects in the proximity of the speaker 352. The processor 204 may determine when the reflected radio signal level is greater than or equal to the threshold value, for example. When the processor 204 determines that one or more objects are in the proximity of the speaker 352, the processor 204 may communicate a signal to the speaker 352 causing a reduction in the sound pressure level of sound energy generated by the speaker 352.

When a subsequent radio signal level is less than the threshold level, the proximity detector 360 may enable a determination of whether there are no objects detected in the proximity of the speaker 352. The processor 204 may determine when the reflected radio signal level is less than the threshold value, for example. When the processor 204 determines that there are no objects are in the proximity of the speaker 352, the processor 204 may communicate a signal to the speaker 352 causing an increase in the sound pressure level of sound energy generated by the speaker 352.

In another exemplary embodiment of the invention, the proximity detector 360 may utilize a capacitance sensor. In this embodiment, the proximity detector 360 may comprise an electrically conductive sheet on at least a portion of the surface of the speaker 352. An initial capacitance may be associated with the electrically conductive sheet. Based on the initial capacitance, an initial current and/or voltage signal may be communicated to the processor 204 by the proximity detector 360.

When an object establishes physical contact with the capacitance sensor, the electrical conductivity properties of the object may interact with the initial capacitance to produce a modified capacitance whose value may differ from the initial capacitance. Based on the modified capacitance, the proximity detector 360 may generate a modified current and/or voltage signal. The modified current and/or voltage signal may be communicated to the processor 204 by the proximity detector 360. Based on a threshold level of change in current and/or voltage level between the initial current and/or voltage signal, and the modified current and/or voltage signal, the proximity detector 360 may enable detection of one or more objects in the proximity of the speaker 352. The processor 204 may determine when the level of change in current and/or voltage level is greater than or equal to the threshold level, for example. When the processor 204 determines one or more objects in the proximity of the speaker 352, the processor 204 may communicate a signal to the speaker 352 causing a reduction in the sound pressure level of sound energy generated by the speaker 352.

When a subsequent level of change in current and/or voltage level between the initial current and/or voltage signal, and current modified current and/or voltage signal is less than the threshold level, the proximity detector 360 may enable a determination that there are no objects detected in the proximity of the speaker 352. This may occur when the object is no longer in physical contact with the capacitance sensor, for example. The processor 204 may determine when the level of change in current and/or voltage level is less than the threshold value, for example. When the processor 204 determines that there are no objects in the proximity of the speaker 352, the processor 204 may communicate a signal to the speaker 352 causing an increase in the sound pressure level of sound energy generated by the speaker 352.

In another exemplary embodiment of the invention, the proximity detector 360 may utilize an infrared sensor. In this embodiment, the proximity detector 360 may comprise a thermally conductive sheet on at least a portion of the surface of the speaker 352. The thermally conductive sheet may convert a detected temperature level to a resistance, for example. An initial resistance may be associated with the thermally conductive sheet. Based on the initial resistance, an initial current and/or voltage signal may be communicated to the processor 204 by the proximity detector 360.

When an object approaches the IR sensor, thermal energy radiated by the object may be detected by the thermally conductive sheet. The detected thermal energy from the object may produce a modified resistance whose value may differ from the initial resistance. Based on the modified resistance, the proximity detector 360 may generate a modified current and/or voltage signal. The modified current and/or voltage signal may be communicated to the processor 204 by the proximity detector 360. Based on a threshold level of change in current and/or voltage level between the initial current and/or voltage signal, and the modified current and/or voltage signal, the proximity detector 360 may enable detection of one or more objects in the proximity of the speaker 352. The processor 204 may determine when the level of change in current and/or voltage level is greater than or equal to the threshold level, for example. When the processor 204 determines that one or more objects are in the proximity of the speaker 352, the processor 204 may communicate a signal to the speaker 352 causing a reduction in the sound pressure level of sound energy generated by the speaker 352.

When a subsequent level of change in current and/or voltage level between the initial current and/or voltage signal, and current modified current and/or voltage signal is less than the threshold level, the proximity detector 360 may enable a determination of whether there are no objects detected in the proximity of the speaker 352. This may occur when the thermal energy from the object is no longer detected at the IR sensor, for example. The processor 204 may determine when the level of change in current and/or voltage level is less than the threshold value, for example. When the processor 204 determines that no objects are in the proximity of the speaker 352, the processor 204 may communicate a signal to the speaker 352 causing an increase in the sound pressure level of sound energy generated by the speaker 352.

FIG. 2C is a block diagram of a rear view of an exemplary mobile terminal illustrating discrete proximity detector and speaker components, in accordance with an embodiment of the invention. FIG. 2C differs from FIG. 2B in that FIG. 2C illustrates an exemplary embodiment of the invention in which the proximity detector is external to the speaker. Referring to FIG. 2C, there is shown a rear view of a mobile terminal 372. The corresponding front view of the mobile terminal 372 may be as described in FIG. 2A. The mobile terminal 302 may comprise a capture and send button 304, a microphone 310, an antenna 312, an IR interface 318, an expansion card 354, a battery 356, a speaker 374, and a proximity detector 380. The capture and send button 304, the microphone 310, the antenna 312, and the IR interface 318 may be as described in FIG. 2A. The expansion card 354, and battery 356 may be as described in FIG. 2B. The speaker 374 may be substantially as described for the speaker 228 (FIG. 1). The proximity detector 380 may be substantially as described for the proximity detector 360 (FIG. 2B).

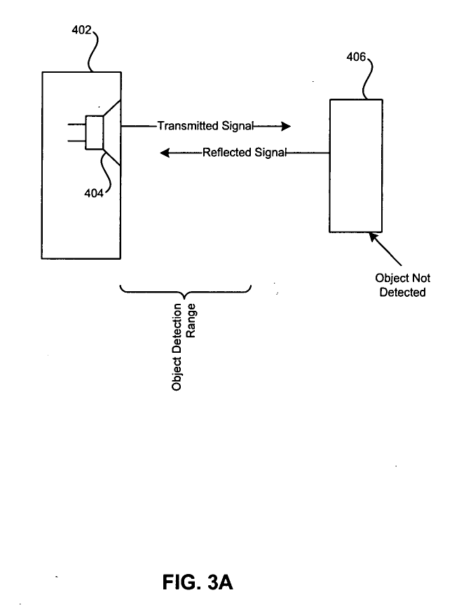

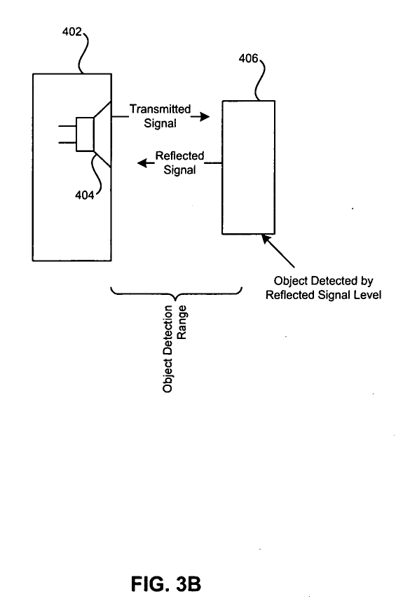

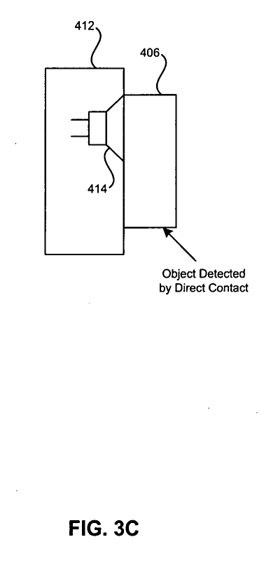

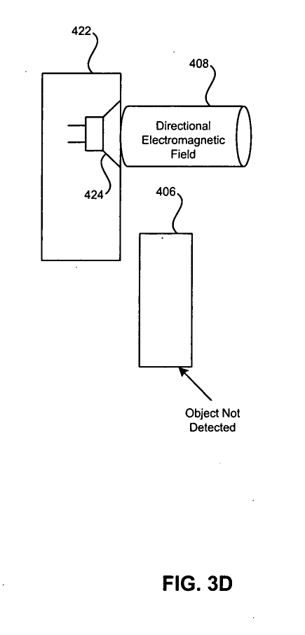

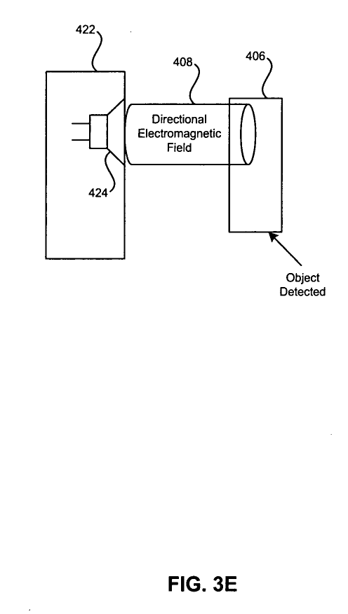

FIG. 3A is a diagram illustrating exemplary non-detection of an object by a speaker with proximity sensing, in accordance with an embodiment of the invention. Referring to FIG. 3A, there is shown a mobile terminal 402, a speaker with proximity sensing 404, and an object 406. In FIG. 3A, the object 406 lies beyond the range of detection for the speaker with proximity sensing 404. The speaker with proximity sensing 404 may determine that the object 404 is beyond the range of detection by transmitting a signal, and detecting a signal level for a reflected signal from the object 406. The reflected signal may be a version of the transmitted signal that has been reflected by the object 406. Consequently, the object 406 may not be detected by the speaker with proximity sensing 404.

FIG. 3B is a diagram illustrating exemplary detection of an object by a speaker with proximity sensing, in accordance with an embodiment of the invention. Referring to FIG. 3B, there is shown a mobile terminal 402, a speaker with proximity sensing 404, and an object 406. In FIG. 3B, the object 406 lies within the range of detection for the speaker with proximity sensing 404. The speaker with proximity sensing 404 may determine that the object 404 is within the range of detection by transmitting a signal, and detecting a signal level for a reflected signal from the object 406. The reflected signal may be a version of the transmitted signal that has been reflected by the object 406. Consequently, the object 406 may be detected by the speaker with proximity sensing 404.

FIG. 3C is a diagram illustrating exemplary detection of an object by a speaker with direct contact sensing, in accordance with an embodiment of the invention. Referring to FIG. 3C, there is shown a mobile terminal 412, a speaker with direct contact sensing 414, and an object 406. In FIG. 3C, the speaker with direct contact sensing 414 may detect an object 406 when the object 406 is in direct contact with the speaker direct contact sensing 414. Consequently, the object 406 may be detected by the speaker with direct contact sensing 414.

FIG. 3b is a diagram illustrating exemplary non-detection of an object by a speaker with proximity sensing based on electromagnetic field perturbation, in accordance with an embodiment of the invention. Referring to FIG. 3D, there is shown a mobile terminal 422, a speaker with proximity sensing 424, an object 406, and a directional electromagnetic field 408. In FIG. 3D, the object 406 lies outside of the region of detection for the speaker with proximity sensing 424. The speaker with proximity sensing 424 may determine that the object 406 lies outside of the region of detection when the object is not coincident with the directional electromagnetic field 408. Consequently, the object 406 may not be detected by the speaker with proximity sensing 424.

FIG. 3E is a diagram illustrating exemplary detection of an object by a speaker with proximity sensing based on electromagnetic field perturbation, in accordance with an embodiment of the invention. Referring to FIG. 3D, there is shown a mobile terminal 422, a speaker with proximity sensing 424, an object 406, and a directional electromagnetic field 408. In FIG. 3D, the object 406 lies within of the region of detection for the speaker with proximity sensing 424. The speaker with proximity sensing 424 may determine that the object 406 lies within of the region of detection when at least a portion of the object 408 is coincident with the directional electromagnetic field 408. Consequently, the object 406 may be detected by the speaker with proximity sensing 424.

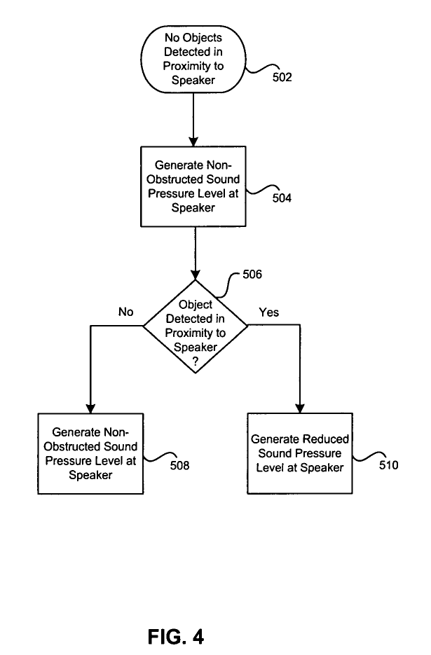

FIG. 4 is a flow chart illustrating exemplary steps for an audio speaker with proximity sensing, in accordance with an embodiment of the invention. Referring to FIG. 4, in step 502, no objects may be detected in proximity to the speaker. In step 504, a speaker 352 may generate audio output at a non-obstructed sound pressure level. The non-obstructed sound pressure level may correspond to a volume level for audio output from the speaker 352 when no objects are detected in the proximity of the speaker 352. Step 506 may determine if one or more objects are detected in proximity to the speaker 352. When step 506 determines that there are no detected objects in the proximity of the speaker 352, in step 508, the speaker 352 may continue to generate audio output at the non-obstructed sound pressure level. When step 506 determines that there are detected objects in the proximity of the speaker 352, in step 510, the speaker 352 may generate audio output at a reduced sound pressure level.

Aspects of a system for audio signal processing may include a proximity detector 360 that enables adjustment of audio volume of a speaker 352 in a wireless communication system, such as a mobile terminal 302, based on detection of a location of at least one object in relation to the speaker 352. The proximity detector 360 may enable generation of a voltage signal and/or a current signal, based on the location of the one or more objects. The proximity detector 360 may enable generation of the voltage signal and/or current signal by emitting light and detecting a level of reflected generated light. The proximity detector 360 may also enable generation of the voltage signal and/or current signal by transmitting an electromagnetic signal and detecting a level of reflection of the transmitted electromagnetic signal. The proximity detector 360 may enable generation of the voltage signal and/or current signal by detecting a level of thermal energy radiated from the one or more objects.

The proximity detector 360 may enable detection of a difference in a level of the voltage signal and/or current signal in comparison to a level of a subsequent voltage signal and/or a subsequent current signal, based on the location of the one or more objects. The proximity detector 360 may enable detection of the difference by comparing at least one initial measurement value for an electromagnetic field to a corresponding at least one modified measurement value for the electromagnetic field. The corresponding at least one modified measurement value for the electromagnetic field may be based on the location of the one or more objects. The at least one initial measurement value, and the corresponding at least one modified measurement value may each comprise a frequency, a direction vector, and/or an amplitude.

The proximity detector 360 may enable generation of a directional electromagnetic field wherein the directional electromagnetic field may detect the one or more objects when at least a portion of the one or more objects is located within an area that is coincident with the directional electromagnetic field. The proximity detector 360 may enable detection of the difference by comparing an initial capacitance to a corresponding modified capacitance, wherein the corresponding modified capacitance may be due to contact with an electrically conductive sheet affixed to the speaker 352 by the one or more objects.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for audio signal processing, the method comprising: adjusting audio volume of a speaker in a wireless communication system based on detection of a location of at least one object in relation to said speaker.

2. The method according to claim 1, further comprising generating at least one of: a voltage signal and a current signal, based on said location of said at least one object.

3. The method according to claim 2, further comprising generating said at least one of: said voltage signal and said current signal, by emitting light and detecting a level of reflected said generated light.

4. The method according to claim 2, further comprising generating said at least one of: said voltage signal and said current signal, by transmitting an electromagnetic signal and detecting a level of reflection of said transmitted electromagnetic signal.

5. The method according to claim 2, further comprising generating said at least one of: said voltage signal and said current signal by detecting a level of thermal energy radiated from said at least one object.

6. The method according to claim 2, further comprising detecting a difference in a level of said at least one of: said voltage signal and said current signal, and a level of at least one of: a subsequent voltage signal and a subsequent current signal, based on said location of said at least one object.

7. The method according to claim 6, further comprising detecting said difference by comparing at least one initial measurement value for an electromagnetic field to a corresponding at least one modified measurement value for said electromagnetic field.

8. The method according to claim 7, wherein said corresponding at least one modified measurement value for said electromagnetic field is based on said location of said at least one object.

9. The method according to claim 7, wherein said at least one initial measurement value, and said corresponding at least one modified measurement value each comprises at least one of: a frequency, a direction vector, and an amplitude.

10. The method according to claim 7, further comprising generating a directional said electromagnetic field wherein said directional magnetic field detects said at least one object when at least a portion of said at least one object is located within an area that is coincident with said directional electromagnetic field.

11. The method according to claim 6, further comprising detecting said difference by comparing an initial capacitance to a corresponding modified capacitance.

12. The method according to claim 11, wherein said corresponding modified capacitance is due to contact with an electrically conductive sheet affixed to said speaker by said at least one object.

13. A system for audio signal processing, the system comprising: circuitry that enables adjustment of audio volume of a speaker in a wireless communication system based on detection of a location of at least one object in relation to said speaker.

14. The system according to claim 13, wherein said circuitry enables generation of at least one of: a voltage signal and a current signal, based on said location of said at least one object.

15. The system according to claim 14, wherein said circuitry enables generation of said at least one of: said voltage signal and said current signal, by emitting light and detecting a level of reflected said generated light.

16. The system according to claim 14, wherein said circuitry enables generation of said at least one of: said voltage signal and said current signal, by transmitting an electromagnetic signal and detecting a level of reflection of said transmitted electromagnetic signal.

17. The system according to claim 14, wherein said circuitry enables generation of said at least one of: said voltage signal and said current signal by detecting a level of thermal energy radiated from said at least one object.

18. The system according to claim 14, wherein said circuitry enables detection of a difference in a level of said at least one of: said voltage signal and said current signal, and a level of at least one of: a subsequent voltage signal and a subsequent current signal, based on said location of said at least one object.

19. The system according to claim 18, wherein said circuitry enables detection of said difference by comparing at least one initial measurement value for an electromagnetic field to a corresponding at least one modified measurement value for said electromagnetic field.

20. The system according to claim 19, wherein said corresponding at least one modified measurement value for said electromagnetic field is based on said location of said at least one object.

21. The system according to claim 19, wherein said at least one initial measurement value, and said corresponding at least one modified measurement value each comprises at least one of: a frequency, a direction vector, and an amplitude.

22. The system according to claim 19, wherein said circuitry enables generation of a directional said electromagnetic field wherein said directional magnetic field detects said at least one object when at least a portion of said at least one object is located within an area that is coincident with said directional electromagnetic field.

23. The system according to claim 18, wherein said circuitry enables detection of said difference by comparing an initial capacitance to a corresponding modified capacitance.

24. The system according to claim 23, wherein said corresponding modified capacitance is due to contact with an electrically conductive sheet affixed to said speaker by said at least one object.
